(19) United States
(12) Patent Application Publication
(10) Pub. No.: US 2009/0189444 A1
(43) Pub. Date: Jul. 30, 2009

(54) Power supply system and ramp strategy

(76) Inventors: Donald Miles Currie, Fairview, IL (US); Mark Edward Hartman, Peoria, IL (US); Benjamin Paul Gottemoller, Peoria, IL (US); Matthew Lee Boggs, Metamora, IL (US)

Correspondence Address: CATERPILLAR/FINNEGAN, HENDERSON, L.L.P., 901 New York Avenue, NW, WASHINGTON, DC, 20001-4413, US

(21) Appl. No.: 12/010,466

(22) Filed: Jan. 25, 2008

(51) Int. Cl. H02J 1/10

(52) U.S. Cl. 307/18

(57) ABSTRACT

A power supply system for supplying power to a load is disclosed. The power supply system includes a power source, a high voltage terminal coupled to the power source, a programmable controller coupled to the power source, and a first low voltage terminal and a second low voltage terminal. Each low voltage terminal is coupled to the programmable controller. The programmable controller may be programmed to switch each of the first and second low voltage terminals between a connected state and a disconnected state and to implement a power up strategy when initially supplying power to the load.

### TECHNICAL FIELD

The present disclosure relates generally to power supply systems, and more particularly, to a power supply system that implements a ramp strategy for powering a load.

### BACKGROUND

Power supply systems may include logic that controls the amount of power supplied to a load during power up of the power supply. In one such system, described in U.S. Patent Application Publication No. 2006/0170290 A1, a controller controls a number of power switches in order to supply power to a load. The switches are connected to a power source to control the amount of power supplied by the source, and may ramp up power supplied by the source during power up of the power supply. The system described in the '290 Publication includes only one return line from the load to the power supply. For certain loads, however, such as those that employ inverters/converters, it may be necessary to include a two or more return lines from the load to the power supply, in order to create the alternating current necessary to induce a voltage. In addition, some of these loads require large amounts of current and cause an initial power surge upon power up, which in turn requires a large wattage power supply system, which can be undesirable.

The disclosed start-up method is directed to overcoming one or more of the problems set forth above.

### SUMMARY OF THE INVENTION

In one embodiment, a power supply system for supplying power to a load is disclosed. The power supply system includes a power source, a high voltage terminal coupled to the power source, a programmable controller coupled to the power source, and a first low voltage terminal and a second low voltage terminal. Each low voltage terminal may be coupled to the programmable controller. In one embodiment, the programmable controller may be programmed to switch each of the first and second low voltage terminals between a connected state and a disconnected state and to implement a power up strategy when initially supplying power to the load.

In another embodiment, a method for implementing a power up ramp strategy is disclosed. The method includes connecting a high voltage terminal of a power supply to a load through a high voltage line, connecting a first low voltage terminal of a power supply to a load through a first low voltage line, and connecting a second low voltage terminal of a power supply to a load through a second low voltage line. The method additionally includes switching each of the first and second low voltage lines between a connected state and a disconnected state and also includes implementing a ramp strategy that gradually increases the duty cycle for the connected state of each low voltage line until the duty cycle reaches a steady state, when initially supplying power to the load.

In a further embodiment, a programmable controller for controlling the supply of power to a load is disclosed. The programmable controller includes a plurality of switches, each switch configured to cause a low voltage line coupled to the switch to alternately switch between a connected state where the low voltage line is connected to a power source of a power supply, and a disconnected state where the low voltage line is disconnected from the power source of the power supply. The programmable controller further includes programmable logic programmed to cause the power supply to implement a ramp strategy when initially supplying power to a load. In one embodiment, the ramp strategy gradually increases the duty cycle for the connected state for each switch until the duty cycle for each switch reaches a steady state.

### BRIEF DESCRIPTION OF THE DRAWINGS

FIG. 1 is a block diagram illustrating an exemplary power supply system consistent with certain embodiments;

FIG. 2 is an illustration of an exemplary ramp strategy for powering up a load, consistent with certain disclosed embodiments;

FIG. 3 is a flow chart illustrating an exemplary ramp strategy power up method, consistent with certain disclosed embodiments; and

FIG. 4 is a block diagram illustrating an exemplary power supply system and load consistent with certain embodiments.

### DETAILED DESCRIPTION

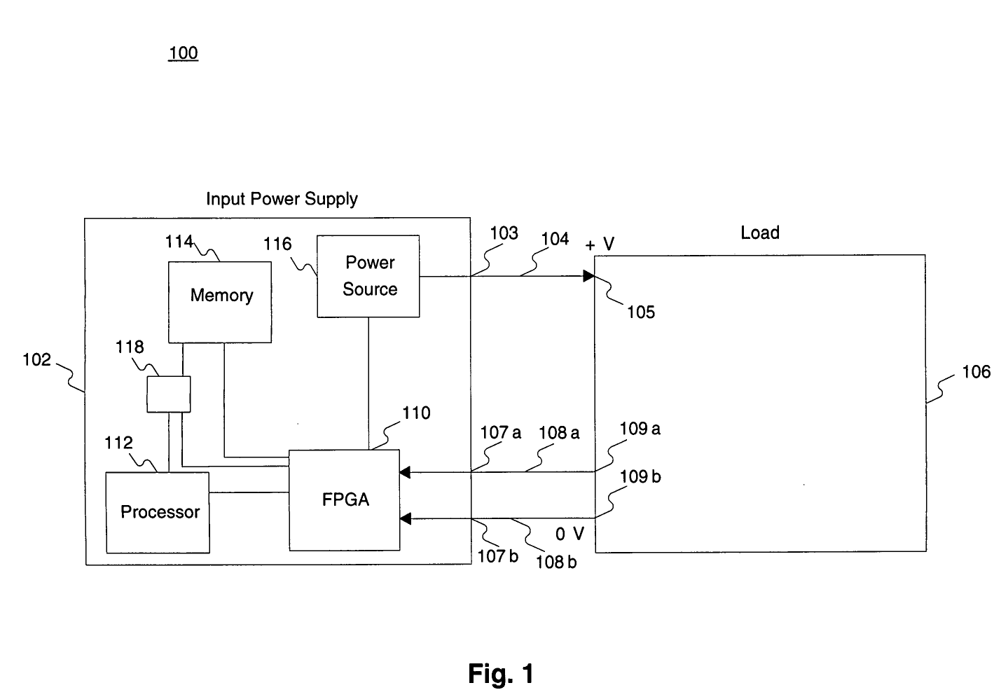

FIG. 1 is a block diagram illustrating an exemplary power supply system 100 consistent with certain disclosed embodiments. In one embodiment, power supply system 100 includes input power supply 102, a high voltage line 104, load 106, and two low voltage return lines 108a and 108b. Associated with input power supply 102 may be a high voltage terminal 103, two or more low voltage terminals (e.g., 107a and 107b), a controller 110 (e.g., a Field Programmable Gate Array (FPGA) or other programmable controller), processor 112, memory 114, power source 116, and internal power supply 118. Additional circuitry and system elements (e.g., additional memory or processors, data links, voltage regulators, switches, and other circuit elements) may also be included in power supply system 100.

In one embodiment, input power supply is configured to supply power to a load. For example, in one embodiment, input power supply 102 includes a power source 116 (e.g., a battery, generator, or other known power source) for providing power to a load, and may include a high voltage terminal 103 for connecting to a high voltage line 104 and two or more low voltage terminals 107a and 107b for connecting to two or more low voltage return lines 108a and 108b. The terminals may be any known electrical or electro-mechanical component capable of joining elements of an electronic circuit together. The voltage supplied by input power supply 102 may be any desired voltage suitable to power the load 106 (e.g., 12 V, 24 V, etc.). In one embodiment, the power source 116 for input power supply 102 may be a DC (direct current) power source.

Load 106 may be any load that derives power from input power supply 102. For example, in one embodiment, load 106 is a power converter system (also referred to as “inverter”), that includes a transformer that supplies power to a secondary system. In one embodiment, load 106 includes one or more capacitors, which may be charged during power up of input power supply 102.

In one embodiment, load 106 includes one high voltage terminal 105 and two low voltage return terminals 109a and 109b. High voltage terminal 105 may be connected to a high voltage line 104, which may further connect to high voltage terminal 103 of input power supply 102. The low voltage return terminals 109a and 109b may each be connected to separate low voltage lines 108a and 108b, which may each connect to a low voltage terminals 107a and 107b of input power supply 102. In one embodiment, low voltage lines 108a and 108b each connect to a low voltage terminal of input power supply 102 and further connect to a controller 110, such as an FPGA or other programmable circuitry. Although the terms “high” voltage and “low” voltage are used, the terms do not necessarily indicate a value of voltage supplied to either terminal. Rather, the terms “high voltage line” and “low voltage line” are relative terms used to indicate that one line (e.g., the “high” line) is at a higher voltage than the other line (e.g., the “low” line or “return” line). For example, in one embodiment, the high voltage line 104 may be a positive voltage line, and the low voltage lines 108a and 108b may be zero voltage lines (e.g., ground) or negative voltage lines.

Input power supply 102 may further include processor 112, memory 114, internal power supply 118, and other elements that may be used together with controller 110 to control the power supplied to the load. In one embodiment, for example, processor 112 may include a microprocessor, such as a Freescale MPC 563™ or Freescale Power PC™, used to control input power supply 102. Memory 114 may include one or more Flash memory, SRAM, EEPROM, or other storage modules used to store certain control programs and other data. Internal power supply 118 may be used to power the logical components of input power supply 102. Other known microprocessors and/or memory modules may be included in input power supply 102 as well. Furthermore, controller 110, processor 112, memory 114, power source 116, internal power supply 118, and other components connected to input power supply 102 may be integrated as part of input power supply 102, connected internally to input power supply 102, connected externally to input power supply 102, or coupled to input power supply 102 in any other way.

In an exemplary embodiment, controller 110 may be coupled to high voltage line 104, return lines 108a and 108b, processor 112, memory 114, power source 116, and/or internal power supply 118, and may be programmed to cause each of return lines 108a and 108b to alternatively switch between being open (e.g., disconnected state) and closed (e.g., connected state). For example, for each return line, the controller 110 may be programmed to regulate a switch (e.g., a MOSFET switch, or other electronic switch) that alternately connects and disconnects the return line, and thus the power supply terminal (e.g., 107a or 107b) to which it is connected, to the power source 116, thereby alternating between supplying current to load 106 and supplying no current to load 106. Each switch may be programmed by a user or computer to implement a desired frequency and duty cycle for switching between a connected state and a disconnected state. The frequency may depend, for example, on a system clock (not shown) having a set frequency, and a programmed clock pulse resolution setting that controls the switching frequency of the switch. By including controller 110 with the input power supply 102, a user can easily program a ramp strategy or other power up strategy to be used to power the load 106.

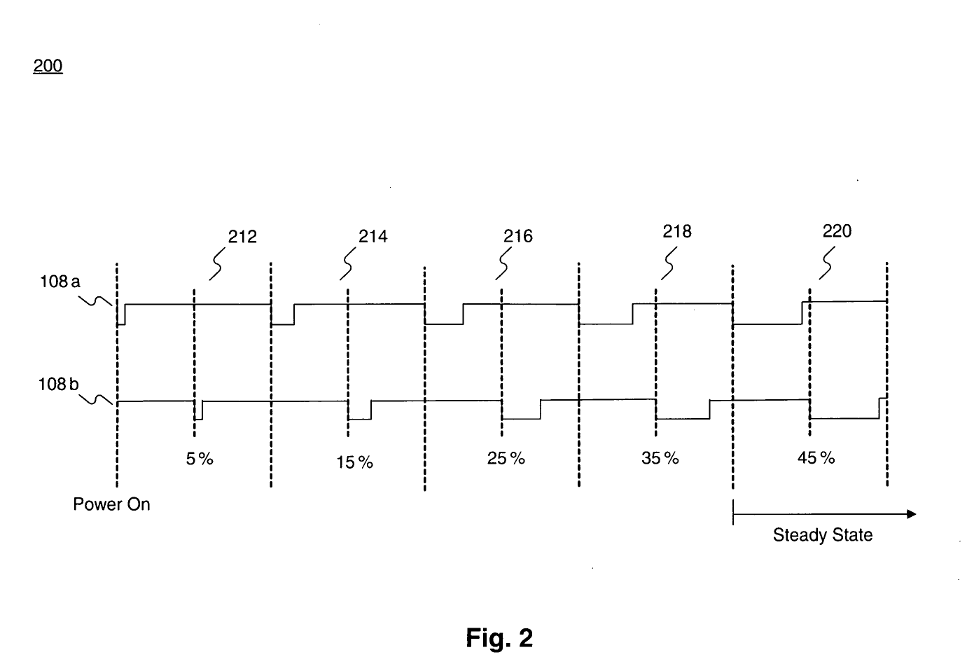

In one embodiment, as depicted in FIG. 2, controller 110 modulates the duty cycle for each return line such that each line “ramps up” from a shorter connected duration to a longer connected duration. For example, in the exemplary ramp strategy 200 depicted in FIG. 2, a duty cycle for each return line 108a and 108b begins at 5% (e.g., the return line is in the connected state and input power supply 102 supplies power to load 106 for 5% of the cycle, and then the return line is in the disconnected state and input power supply 102 supplies no power for 95% of the cycle) during the first cycle 212, increases to 15% during the second cycle 214, increases to 25% during the third cycle 216, increases to 35% during the fourth cycle, and increases to 45% during the fifth cycle. In one embodiment, by reaching 45%, the duty cycle for each return line 108a and 108b reaches a final steady state and remains at 45%. The “low” duration of the duty cycle is depicted in FIG. 2 as the connected state (e.g., the switch is closed and power is being supplied to the load). In one embodiment, the duty cycles for return line 108a and 108b are 180 degrees out of phase, such that under normal operation, the two lines are not both in the connected state at the same time.

Although particular numerical examples are described above with regard to duty cycles and number of cycles before reaching steady state, any desirable ramp strategy (e.g., duty cycle, number of cycles to reach a steady state, etc.) may be used. For example, in one embodiment, a ramp strategy is chosen such that the total amount of time for the duty cycle to ramp up to its final steady state is 400 milliseconds. Furthermore, for different loads, different steady state duty cycles (e.g., between 0% and 100%) may be employed.

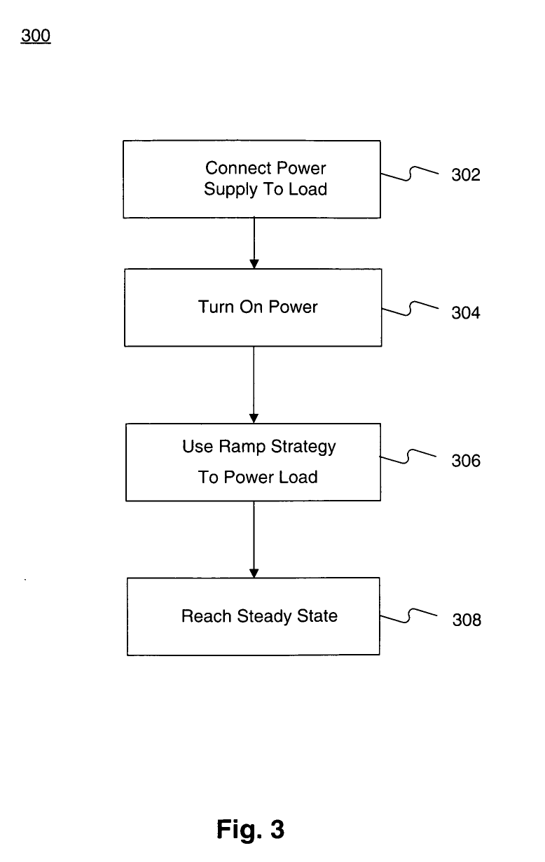

FIG. 3 is a flow chart illustrating an exemplary method 300 of powering up a load using a power up ramp strategy. In step 302, the power supply may be connected to a load. For example, in one embodiment, such as depicted in FIG. 1, a high voltage terminal 103 of power supply 102 is connected to load 106 through high voltage line 104, a first low voltage terminal 107a of power supply 102 is connected to load 106 through first low voltage line 108(a), and a second low voltage terminal 107b of power supply 102 is connected to load 106 through second low voltage line 108(b). In step 304, the power to power supply 102 is turned on. This may be accomplished via an on/off switch, or via some other starter mechanism that causes power supply 102 to begin providing power to load 106. In step 306, a ramp strategy is used to ramp up the power supplied to the load. In one embodiment, a ramp strategy as disclosed in FIG. 2 may be used. That is, the power supply may be used to switch each of a first and second voltage lines (and thus their respective power supply terminals) between a connected state and a disconnected state and to implement a ramp strategy to initially supply power to the load. For example, in one embodiment, the ramp strategy may include gradually increasing the duty cycle for two low voltage return lines that are 180 degrees out of phase. In other embodiments, other ramp strategies may be used. In step 308, the power and current supplied to the load reaches a steady state, such that the duty cycle remains constant.

### INDUSTRIAL APPLICABILITY

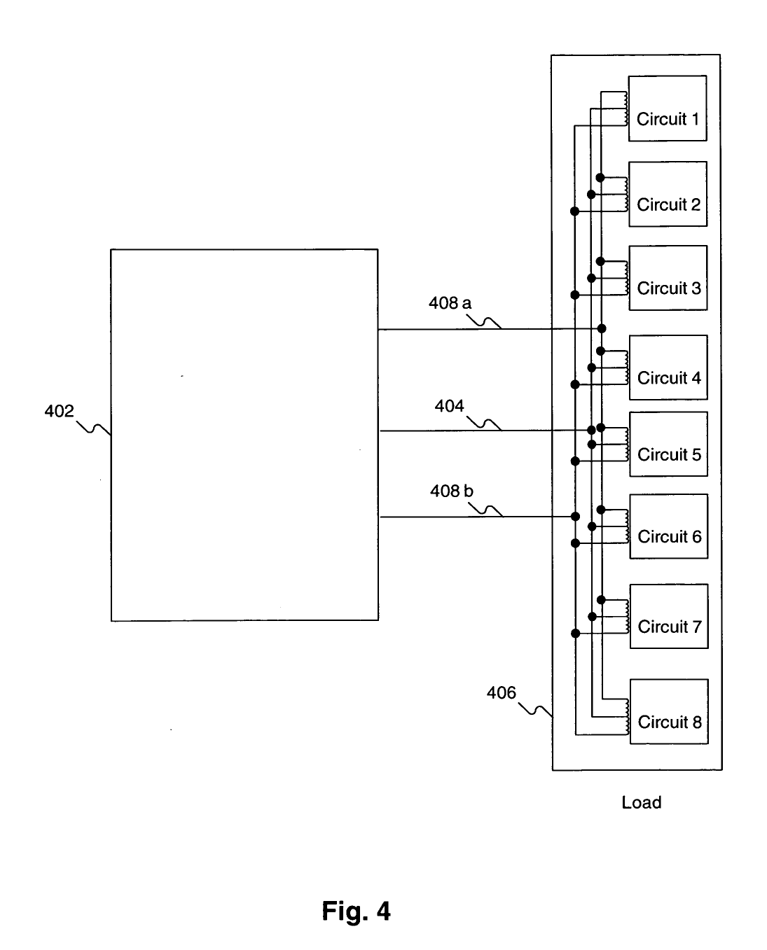

The power supply system and ramp strategy described above may be used to provide power to any load. For example, in one embodiment, the power supply system may be connected to a load that includes a transformer and a secondary load. The power supply system may be connected to a primary coil for a transformer, such that the power supplied is used to induce voltage in a secondary coil to power a secondary load connected to the secondary coil. The primary coil may include a single high voltage terminal and two low voltage terminals. Using a programmed FPGA or other programmable circuit, the return lines connected to the low voltage terminals may alternatively switch between a connected state and a disconnected state according to a ramp strategy, to provide the alternating current necessary to induce the voltage in the secondary coil to power the secondary load. In one embodiment, for example, the load may include a gate driver board, an HVAC system board, or any other load, and may include one or more transformers and one or more associated circuits (i.e., secondary loads). As depicted in FIG. 4, for example, an input power supply 402 may provide a fixed direct current voltage (e.g., 24 V) to the center tap (i.e. terminal) 404 of a primary transformer coil for each transformer at the load 406. The two return lines 408a and 408b may respectively be connected to two remaining end terminals of each primary transformer coil and may employ a ramp strategy to provide an alternating current necessary to induce a voltage in each secondary coil to power and provide sufficient isolation for a given secondary load.

In a further embodiment, the input power supply 102 is part of an electronic control module (e.g., engine control module or machine control module in a vehicle or other engine-powered machine).

By using the disclosed ramp strategy, the power supply system provides a gradually increasing current upon power up, avoiding a power surge and avoiding the need for a large wattage power supply. In addition, by including at least two low voltage return lines, the disclosed power supply system may implement the ramp strategy for loads that may use multiple return lines, such as a transformer having a center tap and two end terminals.

It will be apparent to those skilled in the art that various modifications and variations can be made to the disclosed power supply system. Other embodiments will be apparent to those skilled in the art from consideration of the specification and practice of the disclosed power supply system. It is intended that the specification and examples be considered as exemplary only, with a true scope being indicated by the following claims and their equivalents.

What is claimed is:

1. A power supply system for supplying power to a load, the power supply system comprising:
a power source;
a high voltage terminal coupled to the power source;
a programmable controller coupled to the power source; and
a first low voltage terminal and a second low voltage terminal, each low voltage terminal coupled to the programmable controller;
wherein the programmable controller is programmed to switch each of the first and second low voltage terminals between a connected state and a disconnected state and to implement a power up strategy when initially supplying power to a load.

2. The power supply system of claim 1, wherein the programmable controller is a field programmable gate array (FPGA).

3. The power supply system of claim 1, further including:
a first switch in the programmable controller for switching the first low voltage terminal between the connected state and the disconnected state; and
a second switch in the programmable controller for switching the second low voltage terminal between the connected state and the disconnected state,
wherein the programmable controller is programmed to implement the power up strategy by alternately switching each of the low voltage terminals between a connected state and a disconnected state according to a ramp strategy that gradually increases the duty cycle for the connected state of each low voltage terminal until the duty cycle reaches a steady state.

4. The power supply system of claim 3, wherein:
the programmable controller is programmed to cause the duty cycle for the connected state for each low voltage terminal to reach a steady state of 45%; and
the programmable controller is programmed to cause the first and second switches to be out of phase such that only one of the switches is in the connected state at any time.

5. The power supply system of claim 3, wherein:
the programmable controller is programmed to cause each of the two low voltage terminals to alternate between the connected state and the disconnected state, such that the connected states of the two low voltage terminals are 180 degrees out of phase from each other.

6. The power supply system of claim 3, further including:
a high voltage line connected to the high voltage terminal;
a first low voltage line connected to the first low voltage terminal;
a second low voltage line connected to the second low voltage terminal; and
a load coupled to the high voltage line, the first low voltage line, and the second low voltage line.

7. The power supply system of claim 6, wherein:
the load includes at least one transformer including a center tap, a first end terminal, and a second end terminal;
the high voltage line is connected to the center tap;
the first low voltage line is connected to the first end terminal; and
the second low voltage line is connected to the second end terminal.

8. The power supply system of claim 7, wherein:
the load includes a secondary load coupled to the transformer, and the transformer is configured to supply power to the secondary load.

9. A method for implementing a power up ramp strategy, the method comprising:
connecting a high voltage terminal of a power supply to a load through a high voltage line;
connecting a first low voltage terminal of the power supply to a load through a first low voltage line;
connecting a second low voltage terminal of the power supply to a load through a second low voltage line; and
switching each of the first and second low voltage lines between a connected state and a disconnected state; and
implementing a ramp strategy that gradually increases a duty cycle for the connected state of each low voltage line until the duty cycle reaches a steady state, when initially supplying power to the load.

10. The method of claim 9, wherein:
the power supply includes a programmable controller coupled to the high voltage terminal, the first low voltage terminal, and the second low voltage terminal.

11. The method of claim 10, wherein:
the programmable controller is an FPGA.

12. The method of claim 10, wherein:
the programmable controller includes first and second switches programmed to alternately switch each of the low voltage lines between a connected state and a disconnected state according to the ramp strategy.

13. The method of claim 12, wherein:
the programmable controller is programmed to cause the duty cycle for the connected state for each low voltage line to reach a steady state of 45%; and
the programmable controller is programmed to cause the first and second switches to be out of phase such that only one of the switches is in the connected state at any time.

14. The method of claim 13, wherein:
the programmable controller is programmed to cause each of the two low voltage lines to alternate between the connected state and the disconnected state, such that the connected states of the two low voltage lines are 180 degrees out of phase from each other.

15. The method of claim 9, wherein the load includes one or more transformers, and further comprising:
connecting the power supply to the one or more transformers;
supplying power to the one or more transformers using the ramp strategy; and
supplying power to one or more secondary loads via the one or more transformers.

16. A programmable controller for controlling the supply of power to a load, the programmable controller comprising:
a plurality of switches, each switch configured to cause a low voltage line coupled to the switch to alternately switch between a connected state where the low voltage line is connected to a power source of a power supply, and a disconnected state where the low voltage line is disconnected from the power source of the power supply; and
programmable logic programmed to cause the power supply to implement a ramp strategy when initially supplying power to a load, the ramp strategy gradually increasing the duty cycle for the connected state for each switch until the duty cycle for each switch reaches a steady state.

17. The programmable controller of claim 16, wherein the plurality of switches include a first switch and a second switch, and further including:
programmable logic programmed to cause the duty cycle for the connected state for each low voltage line to reach a steady state of 45%; and
programmable logic programmed to cause the first switch and the second switch to be out of phase such that only one of the first and second switches is in the connected state at any time.

18. The programmable controller of claim 17, further including:
programmable logic programmed to cause each of the two low voltage lines to alternate between the connected state and the disconnected state, such that the connected states of the two low voltage lines are 180 degrees out of phase from each other.

19. The programmable controller of claim 16, wherein the programmable controller is an FPGA.

20. The programmable controller of claim 16, wherein the plurality of switches are two switches.
